(19) United States
(12) Patent Application Publication
(10) Pub. No.: US 2020/0151943 A1
(43) Pub. Date: May 14, 2020

(54) DISPLAY SYSTEM FOR PRESENTATION OF AUGMENTED REALITY CONTENT

(71) Applicant: ARWall, Inc., Westlake Village, CA (US)

(72) Inventors: Eric Navarrette, Burbank, CA (US); Leon Hui, Hawthorne, CA (US)

(21) Appl. No.: 16/682,922

(22) Filed: Nov. 13, 2019

Related U.S. Application Data
(60) Provisional application No. 62/760,268, filed on Nov. 13, 2018.

(51) Int. Cl. G06T 15/20; G06F 3/01; G06T 7/50; G06T 7/70; G02B 27/01

(52) U.S. Cl. CPC G06T 15/20; G06F 3/011; G06T 7/50; G06T 7/70; B60K 35/00; G06T 2207/30196; G02B 2027/0134; G02B 2027/0138; G02B 2027/014; G02B 27/0101

(57) ABSTRACT

There is disclosed a system for generating and displaying augmented reality content on a display that incorporates movement both internally and externally to the display and takes into account the perspective of a viewer so that three-dimensional content may properly perspective shift based upon movement of the viewer or viewers.

### NOTICE OF COPYRIGHTS AND TRADE DRESS

A portion of the disclosure of this patent document contains material which is subject to copyright protection. This patent document may show and/or describe matter which is or may become trade dress of the owner. The copyright and trade dress owner has no objection to the facsimile reproduction by anyone of the patent disclosure as it appears in the Patent and Trademark Office patent files or records, but otherwise reserves all copyright and trade dress rights whatsoever.

### RELATED APPLICATION INFORMATION

This patent claims priority from U.S. provisional patent application No. 62/760,268 filed Nov. 13, 2018 and entitled “DISPLAY SCREENS WITHIN VEHICLES FOR AUGMENTED REALITY PRESENTATIONS FOR EXTERIOR OBJECTS.”

### BACKGROUND

### Field

This disclosure relates to augmented reality displays for use in automobiles, appliances, or other devices and more particularly, to displays that track viewer position and present three-dimensional objects or presentations relative to a viewer's position.

### Description of the Related Art

There exist many forms of presenting information to humans for decision making, entertainment, and other purposes. In the context of automobiles, these include dials, gauges, electronic displays, “heads-up” displays that project images onto windshields, and audio output that uses speech to communicate information. There are similar gauges, dials, displays, remote controls, and other systems for use with televisions, microwaves, refrigerators, small-scale displays, “smart home displays” or “smart home devices” to interact with and provide information to humans.

There also exist numerous companies, hardware products, and software systems that may be used to provide augmented reality or virtual reality immersion for humans. For example, head mounted displays, such as the Oculus® Rift® line of head mounted displays may be used to provide augmented reality (AR) or virtual reality (VR) immersion wherein a human views and, potentially, interacts with AR or VR environments, characters, or objects. The ubiquitous mobile device (e.g. iPhone® or Android® phones or tablets) incorporates cameras and may be used to provide augmented reality experiences whereby a user looks “through” the device into the real world, using a live-captured image of the background, and augmented reality objects or characters may be super-imposed over reality and interacted with by a human.

In an unrelated disclosure by the assignee of this patent, U.S. application Ser. No. 16/210,951, filed Jun. 14, 2019, and entitled “Augmented Reality Wall with Combined Viewer and Camera Tracking;” individuals can film a live-rendered video display wall, wherein a background is presented on the wall and updates perspective according to a tracked position of the viewer and/or a camera. Actors may perform in front of the image, or the image may update so as to appear “more real” to a camera as the background is being filmed. Likewise, the wall may react only to individuals, responding to motion of that individual in front of the display to appear “real” to the viewer in real-time.

### DESCRIPTION OF THE DRAWINGS

FIG. 1 is an overview of a system for presentation of augmented reality objects.

FIG. 2 is a functional diagram of a system for presentation of augmented reality objects.

FIG. 3 is a functional diagram of a computing device.

FIG. 4 is an example of two automobiles moving down a roadway.

FIG. 5 is an example of an augmented reality display integrated with one of the two automobiles moving down a roadway.

FIG. 6 is an example of an augmented reality display integrated with one of the two automobiles moving down a roadway.

FIG. 7 is an example of an augmented reality display integrated with two of the two automobiles moving down a roadway, where one of the automobiles is a first responder vehicle.

FIG. 8 is an example of an augmented reality display integrated within an automobile.

FIG. 9, including FIGS. 9A and 9B, is another example of an augmented reality display integrated with an automobile.

FIG. 10 is an example of an augmented reality display integrated into an appliance.

FIG. 11 is an example of an augmented reality display integrated into another appliance.

FIG. 12 is an example of an augmented reality display integrated into a different appliance.

FIG. 13 is a flowchart of a process of generating augmented reality content for an augmented reality display.

Throughout this description, elements appearing in figures are assigned three-digit reference designators, where the most significant digit is the figure number and the two least significant digits are specific to the element. An element that is not described in conjunction with a figure may be presumed to have the same characteristics and function as a previously described element having a reference designator with the same least significant digits.

### DETAILED DESCRIPTION

A better way to present information to an individual, for example, operating a motor vehicle, or to a first responder while operating a motor vehicle, or to an at-home user of an appliance or other electronic device, is desirable. It would be helpful in many cases if such a system were capable of dynamically tracking the position of the human to whom the information is being provided and to track exterior objects, in some cases, such as other moving vehicles, the road, rocks, trees, or other objects; and to present augmented reality information of informative, warning, entertainment, and advertisement types to such viewers.

Similarly, it would be desirable if other appliances and devices capable of display could react to movement of the viewing human as well as other exterior or interior objects to present augmented reality displays. It would be still more advantageous if such a system could enable sensor fusion, for detecting the motion and position of the human and/or exterior or interior objects and/or rendering of such three-dimensional content at a remote location especially for devices lacking in substantial processing power like typical household appliances. That fused sensor data and/or rendered augmented reality three-dimensional objects could then be returned ready-to-display to those devices.

Description of Apparatus

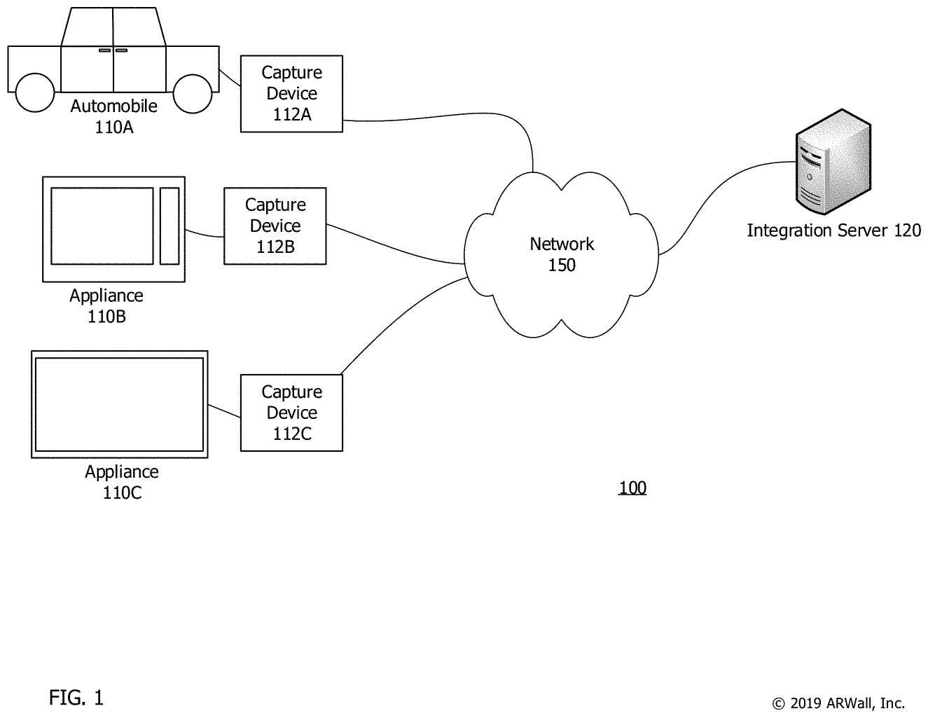

Referring now to FIG. 1, an overview of a system 100 for presentation of augmented reality objects is shown. The system 100 includes an automobile 110A, an associated capture device 112A, an appliance 110B, an associated capture device 112B, an appliance 110C, an associated capture device 112C, and an integration server 120, all interconnected by a network 150.

The automobile 110A is a typical automobile, but may be a motorbike, a truck, a semi-trailer truck, an emergency vehicle such as an ambulance, police vehicle, or fire truck, or special purpose vehicle such as dump truck, crane, boat, or plane. Though not shown in FIG. 1, the automobile 110A includes at least one display and/or projector for displaying augmented reality content to a rider or driver of the automobile 110A.

The capture device 112A is a device including at least one sensor for detecting depth in three-dimensional space and associated movement of objects relative to the automobile 110A. The sensor is preferably several sensors working in concert with one another to generate a reasonably accurate state of the environment in which the automobile 110A is operating.

The capture device 112A is shown as separate from the automobile 110A primarily with an intent to indicate that it may be distinct from the automobile 110A. However, the capture device 112A may be integrated into the automobile 110A and may be in fact many devices integrated within the automobile 110A.

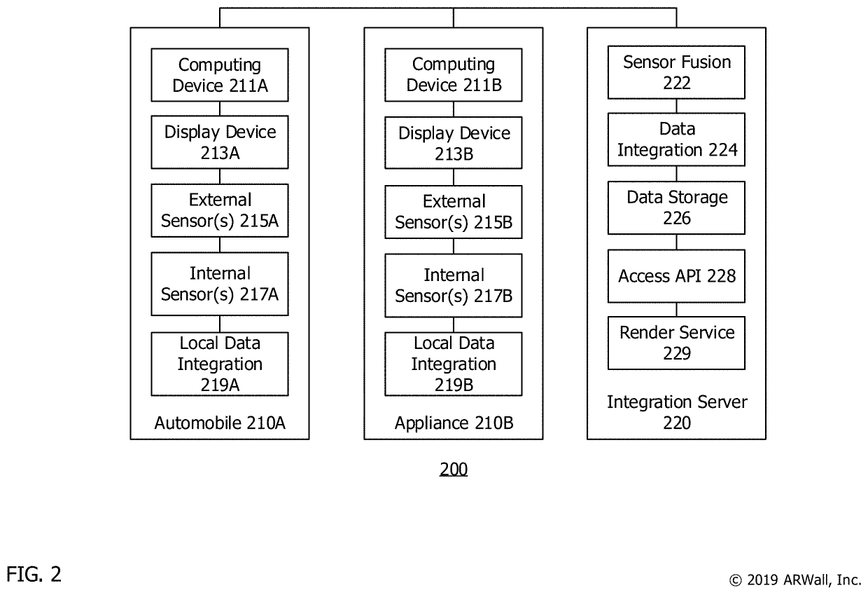

The capture device 112A may be or include a computing device (FIG. 2) and may incorporate both inward-facing (e.g. the interior of the automobile 110A) and outward-facing (e.g. the exterior of the automobile 110A) sensors. The sensors may be or include LIDAR, standard RGB cameras, infrared emitters paired with infrared cameras, light field projectors and associated depth sensors, high-speed cameras, and depth cameras. Different sensors may be used in different environments, for example, infrared emitters and infrared cameras are generally most effective at distances of approximately 20 feet or less, while ineffective at greater distances. Likewise, light field projectors and LIDAR are more effective over larger distances of up to hundreds of feet, but with decreased depth sensing at greater distances. With these characteristics in mind, certain sensors may be used internally and externally from the automobile 110A. The capture device 112A may operate in a substantially continuous fashion or periodically.

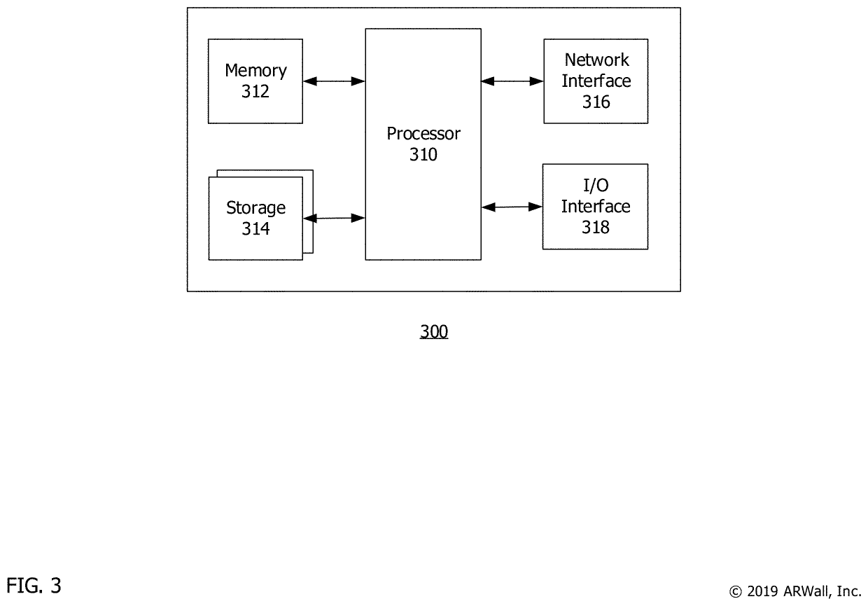

The appliance 110B is shown as a typical microwave. The appliance may incorporate a computing device (FIG. 3). The appliance 110B, however, may take many forms. Televisions (like appliance 110C) may be used, and small “smart display devices” such as the Google® Nest Hub, a refrigerator, a smart photo frame, a smart clothes washer, or other home devices including an integrated display or that could include an integrated display are other examples of appliance 110B.

The capture device 112B is substantially the same as capture device 112A, but with the appliance serving in place of the automobile 110A. Specifically, there may be sensors of the types described above integrated into the appliance 110B. The capture device 112B may operate both internally and externally to the appliance so that, for example, while microwaving, food may be tracked internal to the microwave, while externally a human position relative to the appliance 110B may also be tracked. The capture device 112B may incorporate sensors that are particularly relevant to the appliance 110B, for example, a thermometer for a microwave, oven or refrigerator.

The appliance 110C is substantially the same as appliance 110B, but is shown to demonstrate that appliances or other devices can take many shapes and sizes. The augmented reality display and sensor system of the present patent is intended for use with virtually any device having or capable of having a display and incorporating a capture device, like capture device 112C, which is likewise similar to capture device 112B.

One notable difference is that the capture devices 112B and 112C they may be distinct from the associated appliance (or other device) or may be integral to it. In some cases, a capture device may generate sensor information that is used for rendering a display on still another device. The capture device 112B or 112C need not necessarily be the same as the display device.

Turning now to FIG. 2, a functional diagram of a system 200 for presentation of augmented reality objects is shown. The system 200 includes an automobile 210A, an appliance 210B, and an integration server 220. These are the system 100, automobile 110A, and appliance 110B of FIG. 1, respectively. Individual functional systems within each are shown. It should be noted that a given system need not include both automobile 210A and appliance 210B, but the versatility of the integration server 220 is that it may function with both. Therefore, though there is much overlap in the associated discussion, both are shown as able to interact with, and be serviced by, the integration server 220.

The automobile 210A includes a computing device 211A, a display device 213A, external sensor(s) 215A, internal sensor(s) 217A, and local data integration 219A. The computing device 211A is a computing device (FIG. 3) that may perform many functions for the automobile 210A. The computing device 211A may be special-purpose, designed only to focus on generating three-dimensional content and appropriately altering its perspective for purposes of viewing by a rider in the automobile 210A. Alternatively, the computing device 211A may be general purpose and used for many functions within the automobile 210A such as calculating miles per gallon, providing entertainment functionality, operating digital gauges or sensors, controlling adaptive cruise control, and other, similar, computer-aided functions. In some cases, it may be advisable for cost purposes to use a single more-powerful computing device 211A for many functions, including those described herein. In other cases, it may be advisable for a special-purpose computing device 211A to be used for the processes described herein.

The display device 213A is a screen, projector, holographic display, or a combination of any of these that is designed to display still or moving images to a viewer. The display device 213A may incorporate basic computing functionality to enable it to receive data intended for display and to cause that data to be displayed immediately, or after a short buffer period.

The display device 213A is shown as a single display device, but may in fact be many display devices. In the case of the automobile 210A, the display device 213A may appear in a single window (e.g. the windshield) or may appear in many windows (e.g. each window in the automobile 210A). The display device 213A may be integrated into the window as an LED, LCD, OLED or other format display. Alternatively, one or more projectors may be used to project images onto windows of the automobile 210A or in open space within the automobile 210A so that the images may be seen by riders in the automobile 210A.

The external sensor(s) 215A are sensors external to the automobile 210A that enable the computing device 211A, along with local data integration 219A (discussed below) and potentially the integration server 220, to generate motion, location, depth, and three-dimensional spatial information about surrounding objects for use in generating a three-dimensional representation of those objects or other objects in place of those objects.

As used herein, the phrase “three-dimensional representation” shall mean any augmented reality, virtual reality, or volumetric video that adds to, augments, or replaces some portion of the field of vision of an individual human viewer with a three-dimensional object, character, or location. The “three-dimensional representation” shall, in all cases, be responsive to the location or position of the human viewer, meaning that it will not be presented in exactly the same position relative to a physical object (e.g. a display, an automobile window, or other viewer) at all times. The position will respond to movement of the viewer in a way that corresponds to the way depth of field and perspective would appear to a viewer at a particular distance from the three-dimensional representation as that viewer moves from side-to-side, forward-to-back, or up and down relative to the three-dimensional representation. In this way, the three-dimensional representation appears to have accurate depth, size, and shape.

The external sensor(s) 215A provide sensor data to the computing device 211A to enable it to perform ongoing tracking of objects, cars, roadway, hazards, and other objects near the automobile 210A. This tracking may be used by the computing device 211A to generate three-dimensional representations that are overlays, popups, wholesale alterations, or responsive interactions to the detected objects, and to have those overlays, popups, wholesale alterations, or responsive interactions appropriately “follow” or replace the detected objects.

The external sensor(s) 215A may be or include LIDAR, infrared sensors, motion cameras, high-speed cameras, radar, acoustic sensors for detecting depth, light field projectors and associated sensors, global positioning system sensors, and other, similar sensors. The external sensor(s) 215A may operate in concert with another through a process called sensor fusion to develop a continuously updated picture or, more accurately, depth map, of the exterior world. The sensor fusion may combine detection of objects in motion picture cameras using neural networks with depth maps to identify certain objects as “cars” as opposed to trees, stop signs, or curbs. This and other similar identifications can occur when multiple sources of data are available from the external sensor(s) 215A.

The internal sensor(s) 217A are sensors for detecting movement, location, position, and depth (within a space) for objects within the automobile 210A. In particular, the internal sensor(s) 217A are for detecting the location and perspective of riders within the automobile so that the three-dimensional representations may be presented to the viewer with an accurate, true-to-life perspective. For example, a popup showing the speed of the automobile to the driver may detect that the driver has leaned to her right. In response, the internal sensor(s) 217A will detect this movement, and adjust the position of the speed to a perspective responsive to the driver's shift in position, essentially following the eyes of the driver.

The internal sensor(s) 217A may be separate from or integrated into the display device 213A such that the display device 213A could use its own internal sensor(s) 217A to track the position of a rider's head, or body, or eyes, and adjust the positioning of the images displayed. Preferably, the internal sensor(s) 217A will be spread about the cabin of the automobile 210A so that accurate positions and associated information can be ascertained for all riders in the automobile 210A at any moment. However, in some cases, only sensors for one rider, such as the driver, may be used.

The internal sensor(s) 217A may include sensors for other information relevant to the object into which they are integrated. For example, for the automobile 210A, the internal sensor(s) 217A may include or include access to the speed of the automobile 210A, the revolutions per minute of the engine, and other readouts from the gauges like oil pressure and tire pressure, or other automobile-centric information. For other objects, such as appliance 210B, the internal sensor(s) 217B may include access to temperatures or temperature settings, cooking time, operating times, cycling of a compressor, or other appliance-specific information.

The local data integration 219A is a function responsible for integration of all of the associated data generated by the external sensor(s) 215A and the internal sensor(s) 217A. For example, as the automobile 210A moves down a roadway, it may pass or be near another automobile. The external sensor(s) 215A may be used to detect the presence of, the speed of, and the relative location of the automobile. That information may be continuously updated by the external sensor(s) 215A. Simultaneously, the driver may be moving, even moderately with her head from side-to-side, within the automobile 210A. As a result, if the system described herein wishes to have a hovering “popup” follow the external automobile, for example, providing the estimated speed of that external automobile, and to have that popup appear accurately to a moving driver, the local data integration 219A must take into account the relative position of the automobile and the driver's head and/or eyes. The local data integration 219A continuously updates the relevant vectors and projections to enable the computing device 211A to present a three-dimensional representation for that external automobile following popup to be accurately presented to the driver. This is all seamless to a driver, but the popup may appear to hover or follow the external automobile. As a driver's head and/or the other automobile move still more, the perspective and position of the popup continues to follow the automobile, continuously maintaining appropriate perspective as if it is floating in the air above the external automobile or pasted over the external automobile's exterior door.

Local data integration 219A may be or include sensor fusion like functionalities, as those are understood in virtual reality and augmented reality head worn displays, but one distinction is that there are two sets of data being integrated, rather than one. In AR and VR, only the position, orientation, and rotation of a head-mounted display are being tracked. In the local data integration 219A, the driver's head is tracked for all of that information, but external objects are also tracked for their position, orientation, and rotation (as well as other potential information such as speed and relative depth). The overall integration of these data sets is more processor intensive. For an automobile, it may make sense to have local data integration 219 operate to integrate the various data inputs from the sensors. In less expensive objects, such as appliance 210B, it may make more sense to offload those capabilities to computation in the cloud (e.g. the integration server 220).

The appliance 210B includes a computing device 211B, a display device 213B, external sensor(s) 215B, internal sensor(s) 217B, and local data integration 219B. The appliance 210B is essentially the same as the automobile 210A, but is shown to demonstrate that the same overall system can work with appliances, like appliance 210B, or other household objects incorporating a display or that can operate with a display. These include televisions, microwaves, ovens, smart displays, smart home assistants, desktop and laptop computers, refrigerators, washing machines and dryers, dish washers, copiers, and virtually any other household or office object that integrates or can operate in conjunction with a display. Only the differences between automobile 210A and appliance 210B are pointed out here, but otherwise the various components have similar functions.

The external sensor(s) 215B may flip functions with those of the automobile 210A, because humans are not typically inside a microwave or refrigerator. Thus, the function of the external sensor(s) 215B may be primarily to track external viewers so that an associated three-dimensional representation may be accurately presented on the display. Similarly, the internal sensor(s) 217B may flip functions as well. A microwave may monitor its internal temperature, the location and position of food, and other data associated with the microwave (e.g. time of cooking remaining, wattage, etc.). Nonetheless, the two data sets may still be integrated by the local data integration 219B so that the computing device 211B can generate an appropriate representation (e.g., a three-dimensional representation) for display on the display device 213B. Some examples of appliances will be discussed below.

The integration server 220 is an external computing device (or devices) that are responsible for receiving sensor data from the external sensor(s) 215A and 215B and internal sensor(s) 217A and 217A and generating integration data that may be used to render the three-dimensional representation for the automobile 210A, the appliance 210B or any other object serviced by the integration server 220. The integration server 220 may also provide functionality wherein it actually performs the rendering on behalf of the automobile 210A, the appliance 210B or any other object that requests such a service. This may help to offload the difficult computational task of integrating the data sets in real-time, and of rendering any augmented reality or other three-dimensional representation. Then, the rendered data may be sent back to the respective device and may be displayed. This may enable such devices to have lower-power processing capabilities, and be less costly to manufacture, while still enabling this type of functionality to be used.

The integration server 220 includes sensor fusion 222, data integration 224, data storage 226, an access API 228, and a render service 229. Though the integration server 220 is shown as a single server, it may in fact be many servers, spread across a large geographic area or in many geographic areas, so that it is readily accessible on short latencies to various devices seeking the integration server 220's assistance.

The sensor fusion 222 may receive raw data from the various sensors 215A, 215B, 217A, and 217B for various devices serviced by the integration server 220 and integrate that data into a cohesive whole, suitable for operation upon by the automobile 210A or appliance 210B. The sensor fusion 222 may output a series of quaternion representations of each object in space that are detected by the various sensors.

Data integration 224 is responsible for combining multiple detected objects into a single set of data suitable for rendering upon. In the earlier example, the driver's head may be one object, the moving automobile external to the automobile 210A may be another object. It is the responsibility of the data integration 224 to integrate those two data sets so that the popup may be rendered and may accurately track the external automobile as it moves.

The data storage 226 may store data, algorithms, textures, three-dimensional models, or other information used by the integration server 220 to perform its various functions. For example, specific algorithms may be required for the integration server 220 to perform its functions for different types of requesting devices. The processes for automobiles may be quite distinct from those of refrigerators. Similarly, if the integration server 220 is performing rendering services, it will require three-dimensional models and associated textures to do that rendering. Data storage 226 stores this type of data.

The access API 228 is essentially an authentication system or service. The access API 228 ensures that requesting devices have authorization to access the integration server 220. This may be as simple as an API key or may be as complex as a password-based or RSA two-factor key secured login process. Absent access API 228 authentication, the integration server 220 may refuse to perform functions for requesting devices.

Finally, an optional component is the render server 229. In some cases, devices may lack sufficient rendering capabilities to generate ongoing three-dimensional representations. A ready example may be a microwave. In general, it will not make economic sense to put a powerful processor into a microwave. To provide functionality like rendering on a 30 frames per second, ongoing basis, for example, may not be possible for a microwave. However, if the rendering may be offloaded through a network connection to the integration server 220, then the sensor data may be gathered by the microwave, sent to the integration server 220 over a network connection, rendered by the render service 229, and transmitted back to the microwave as a complete, next frame to be presented on a display integrated into the microwave. In this way, the integration server 220 may provide functionality that is valuable to a consumer.

In such a case, the render service 229 may receive the integrated sensor data from the data integration 224, and may render the next frame of video based upon that data and return it as a single frame of video (two-dimensional, though it may contain three-dimensional representations) and upon receipt of the next set of sensor data, may return the next frame of video. This is all dependent upon relatively low latency, high bandwidth capabilities between the integration server 220 and the appliance (e.g. appliance 210B), but assuming that is available, the render service 229 may operate to provide ongoing frame-by-frame video. This type of video is relatively easily streamed to a display using technology similar to that employed by services like Netflix® for many years (e.g. high-priority TCP transmissions, adaptive resolutions, etc.).

The integration server 220 may incorporate higher powered processing capabilities, including specialized GPUs (graphical processing units) for performing rendering and operating upon the complex mathematical models for the data from the sensors and integrated data generated by data integration 224.

Turning now to FIG. 3, a block diagram of a computing device 300 is shown. The computing device 300 may be representative of the server computers, client devices, mobile devices and other computing devices discussed herein. The computing device 300 may include software and/or hardware for providing functionality and features described herein. The computing device 300 may therefore include one or more of: logic arrays, memories, analog circuits, digital circuits, software, firmware and processors. The hardware and firmware components of the computing device 300 may include various specialized units, circuits, software and interfaces for providing the functionality and features described herein.

The computing device 300 may have a processor 310 coupled to a memory 312, storage 314, a network interface 316 and an I/O interface 318. The processor 310 may be or include one or more microprocessors and application specific integrated circuits (ASICs).

The memory 312 may be or include RAM, ROM, DRAM, SRAM and MRAM, and may include firmware, such as static data or fixed instructions, BIOS, system functions, configuration data, and other routines used during the operation of the computing device 300 and processor 310. The memory 312 also provides a storage area for data and instructions associated with applications and data handled by the processor 310. As used herein, the word memory specifically excludes transitory medium such as signals and propagating waveforms.

The storage 314 may provide non-volatile, bulk or long-term storage of data or instructions in the computing device 300. The storage 314 may take the form of a disk, tape, CD, DVD, SSD, or other reasonably high capacity addressable or serial storage medium. Multiple storage devices may be provided or available to the computing device 300. Some of these storage devices may be external to the computing device 300, such as network storage or cloud-based storage. As used herein, the word storage specifically excludes transitory medium such as signals and propagating waveforms.

The network interface 316 is responsible for communications with external devices using wired and wireless connections reliant upon protocols such as 802.11x, Bluetooth®, Ethernet, satellite communications, and other protocols. The network interface 316 may be or include the internet.

The I/O interface 318 may be or include one or more busses or interfaces for communicating with computer peripherals such as mice, keyboards, cameras, displays, microphones, and the like.

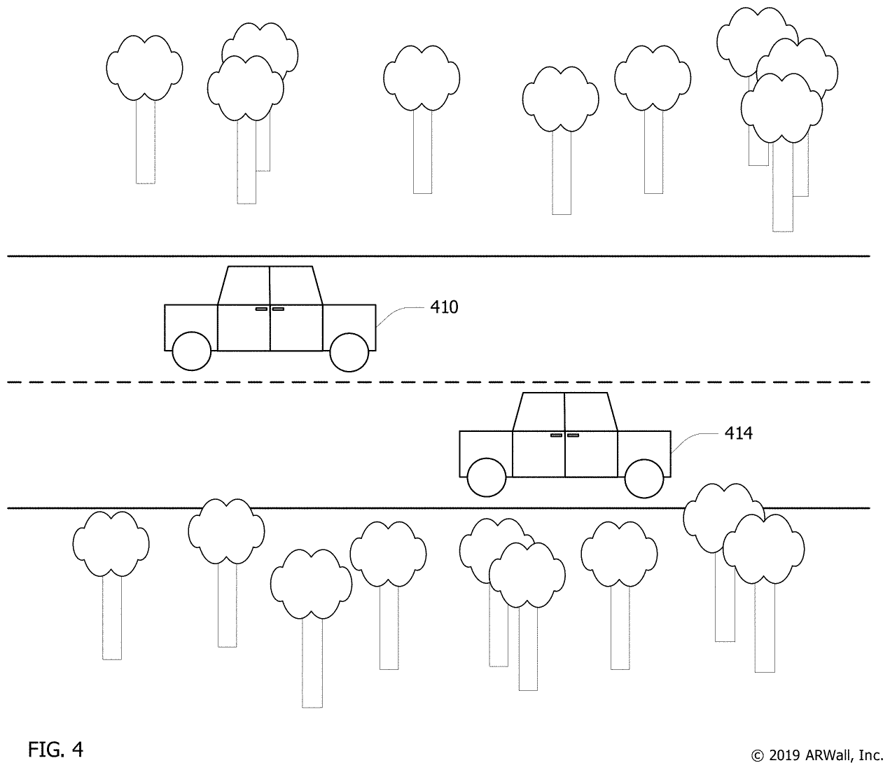

FIGS. 4-12 are examples of the way in which the present system can operate to provide three-dimensional representations.

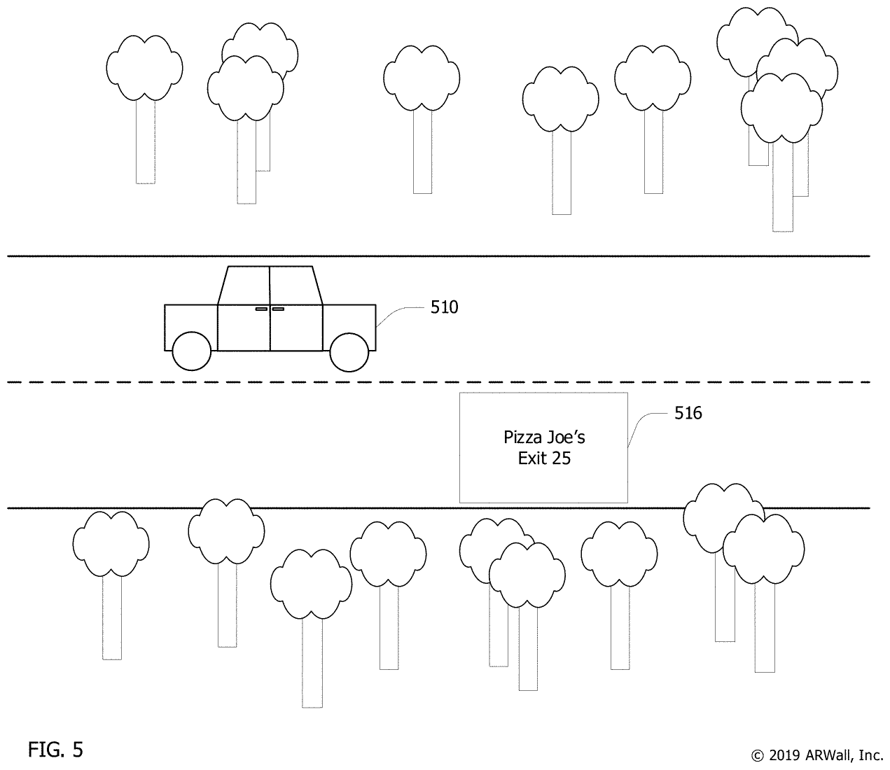

FIG. 4 is an example of two automobiles 410, 414 moving down a roadway. This is merely the groundwork for the discussions of FIGS. 5-7. Automobile 410 and/or automobile 414 may incorporate the system described with respect to FIG. 2.

FIG. 5 is an example of an augmented reality display integrated with one of the two automobiles moving down a roadway. Specifically, automobile 510 has an integrated augmented reality display. From the perspective of automobile 510, automobile 414 (FIG. 4) has now been wholly converted into an advertisement 516 for Pizza Joe's which is on Exit 25.

This example demonstrates a few things simultaneously. First, the three-dimensional representation can completely replace the actual reality in the display device. This requires that the automobile 414 (FIG. 4) be accurately and continuously tracked by the external sensor(s) 215A (FIG. 2). It also requires that the computing device 211A be capable of rendering over the detected location of the automobile 414 (FIG. 4).

In addition, the computing device must be aware of the general location and direction of the automobile 510. To do this, global positioning sensors may be used. In that way, the automobile 510 may have relevant advertisements provided for an upcoming exit, a business nearby on the roadway, an entertainment spectacle that will take place in the near future, or other, information relevant to the driver of the automobile 510.

The advertisement 516 is shown as simply a rectangular billboard. However, the advertisement may be much more complex, given that the computing device 211A is capable of rendering in three dimensions. Specifically, for example, if there were an upcoming film involving Herbie the love bug, then the entire automobile 414 could be replaced with a life-sized (or slightly larger than life-sized) three-dimensional image of Herbie the love bug. There may be associated text, or information regarding the upcoming movie. Herbie may be animated to perform various functions or actions, even actions responsive to interaction by the driver or other passengers in the automobile 510.

For example, Herbie may spit out a digital basketball from its trunk that bounces (digitally) toward the automobile 510 and then appears to be inside the back seat of moving automobile 510. Then, Herbie may open his trunk to request the user to “shoot” the basketball back into his trunk. The user may digitally “lift” the basketball and shoot it from the backseat toward Herbie, where it is captured. This interaction is desirable for advertisers because it is interaction with the brand and may encourage movie attendance. Obviously, significant interaction with drivers would be discouraged, but passengers, may interact with Herbie (or perform similar interactive functions) with augmented reality replacements (or partial replacements) for moving automobiles.

All of that interaction may be enabled by a display or displays within the automobile 510. In other cases, only portions of the automobile 414 (FIG. 4) may be replaced or augmented. Only some augmentations will involve interactive elements. The three-dimensional representations will be three-dimensional and will be responsive to perspective shifts caused by movement of the automobile 510 or even the viewer within the automobile relative to the three-dimensional representation.

Similarly, a fixed billboard, sign, or digital billboard or sign may incorporate encoded or unencoded information that forms the basis of an augmented reality display on an automotive or other window. So, as a car passes an advertisement for the new Herbie the Love Bug movie, additional content, including a miniature, interactive Herbie or actors from the film may appear to be within the car interacting with the driver (through the ongoing tracking of the driver's position, head position, and gaze).

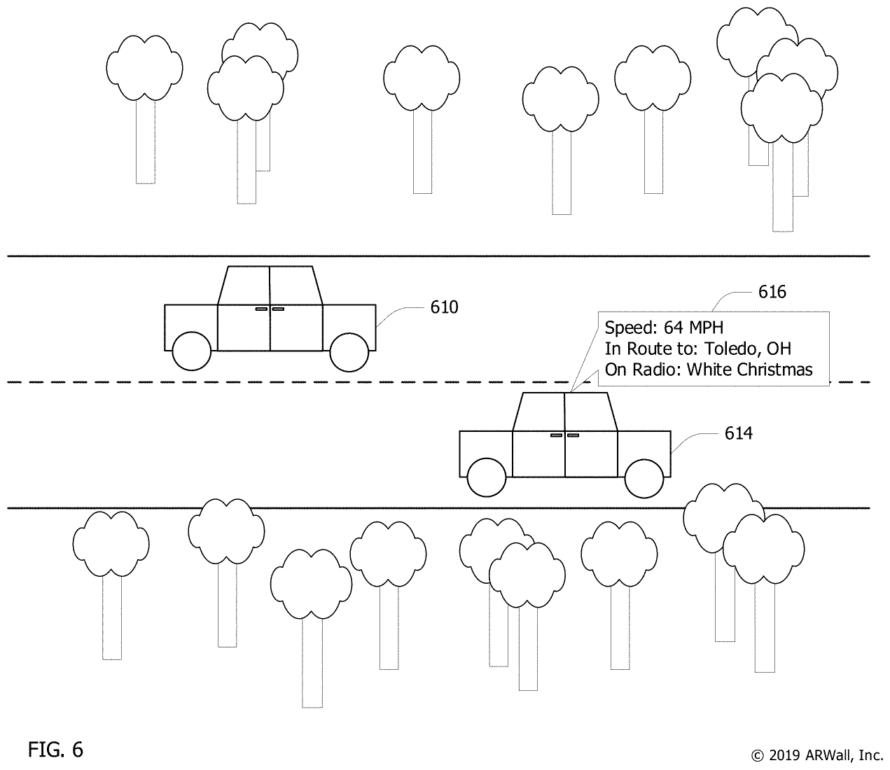

Turning to FIG. 6, an example of an augmented reality display integrated with one of the two automobiles moving down a roadway is shown. Here, automobile 610 includes the system shown in FIG. 2. Automobile 614 may or may not include such a system.

Regardless, the automobile 614 has a three-dimensional representation 616 that in this case provides information about the automobile 614. For example, on a long road trip, a driver of the automobile 614 may elect to share certain information. Here, the speed of the automobile 614 may be shared or may be ascertained independently using the external sensors discussed above. The automobile 610 and 614 may be in short-range or long-range wireless communication with one another using Bluetooth®, 802.11x wireless networking, cellular capabilities of the various iterations, including 5G, or other short-range protocols. Using these communications, data may, in some cases, be passed back and forth between the two automobiles 610, 614.

Satellite networks like Sirius XM and other satellite radio streams may also be utilized. A custom network installed into an automobile, such as OnStar®, could also be used. Networking over IEEE 802.11p and other wireless access in vehicular environments (WAVE) networks could also be used.

In other embodiments other networks such as GSM, GPRS, CDMA, and MOBITEX could be used. Other networking architectures could also be used, such as Personal Area Network (PAN), Local Area Network (LAN), Wireless Local Area Network (WLAN), Campus Area Network (CAN), Metropolitan Area Network (MAN), Wide Area Network (WAN), Storage-Area Network (SAN), System-Area Network (a different SAN but same acronym), Passive Optical Local Area Network (POLAN), Enterprise Private Network (EPN), Virtual Private Network (VPN).

In another alternative, a variation on a Personal Area Network (PAN) can be used to generate an augmented reality display. For example, a computer inside a car can be directly connected via a short-range network to a computer or other device outside of the car. The device outside the car may emit a signal that instructs the computer within the car to create an animation on the augmented reality display. For example, a city that had a boring stretch of freeway could sponsor an AR video to be displayed when drivers drive through the boring stretch of freeway. Rather than drive through a boring stretch of freeway, a scene from Jurassic Park where the driver of the car is taking part in the scene could be displayed to lighten up an otherwise boring drive.

In another embodiment a variation of a Local Area Network (LAN) can be used. In this embodiment the subject AR car can be equipped with a networking device such as a router and other participating vehicles or objects can also be equipped with a router. The participating vehicles can create their own local area network and send signals and data over that network itself.

In other embodiments, the augmented reality display can be connected to the internet itself and simply use the internet network to exchange information with other devices. The car can use AM/FM radio frequencies to send out and receive data. Instead of listening to a regular radio station, the radio waves could relay information to the augmented reality display allowing the augmented reality display to render animations relevant to where the car is, what time of day it is, or what station the car is tuned to. For example, during Christmas, there could be a “Christmas AR station” in which Christmas music plays, and the augmented reality display renders snowy fog as well as reindeer outside the car. If a station specialized in classic rock and had a “Woodstock” special, scenes from Woodstock or a particular concert would be displayed on the window as the driver listens to music.

Alternatively, no network may be used at all. A camera and computer vision system (or other system) may be programmed to identify certain symbols or signals (such as a stop sign, a billboard, a light source, a QR code, RFID, or fiducial marker). These points may be fixed or dynamic (e.g. programmable themselves such as a large billboard emitting certain RFID signals). Enthusiasts could “tag” certain areas or even leave tags on other vehicles. For example, the members of a scooter group could carry RFID tags that when picked up by a car would display a group-associated symbol over the scooter-rider. In contrast, road bikers could carry RFID tags that make them flash or appear larger than they are for safety so automobile drivers know they are there and do not hit them.

In view of those communications, displays within automobile 610 may provide a popup three-dimensional representation 616 that includes information on the route being taken (e.g., Toledo, Ohio) and what is currently playing on the radio (e.g., “White Christmas”). Perhaps this is a holiday trip to their grandmother's home. Importantly, the popup will follow the automobile 614 and shift its perspective based upon any movement of the driver or other riders in the automobile 610. The three-dimensional representation is not actually present, but is displayed on any number of display devices present in the automobile 610.

Markers, such as bumper stickers or QR codes could provide augmented reality information to other drivers such as political statements, statements of college or team affiliation, or “my child is on the honor roll at Oaktree Elementary”. If the vehicles incorporate peer-to-peer communication capabilities, individual communications could be enabled through two vehicles communicating one with another.

Also, advertisements could be transmitted only to certain vehicles such that a single QR code, billboard, or sign could trigger an internet query that incorporates information about the driver of the automobile. In such a case, the relevant advertisement that is returned for viewing by the driver or automobile passengers may be based upon some of that information. So, certain drivers meeting certain characteristics may be presented with certain advertisements while others would see different advertisements. That information may include things like ages, sexes, relevant interests, and the like. All of these may be subject to user preferences related to their desire to share and relevant interests.

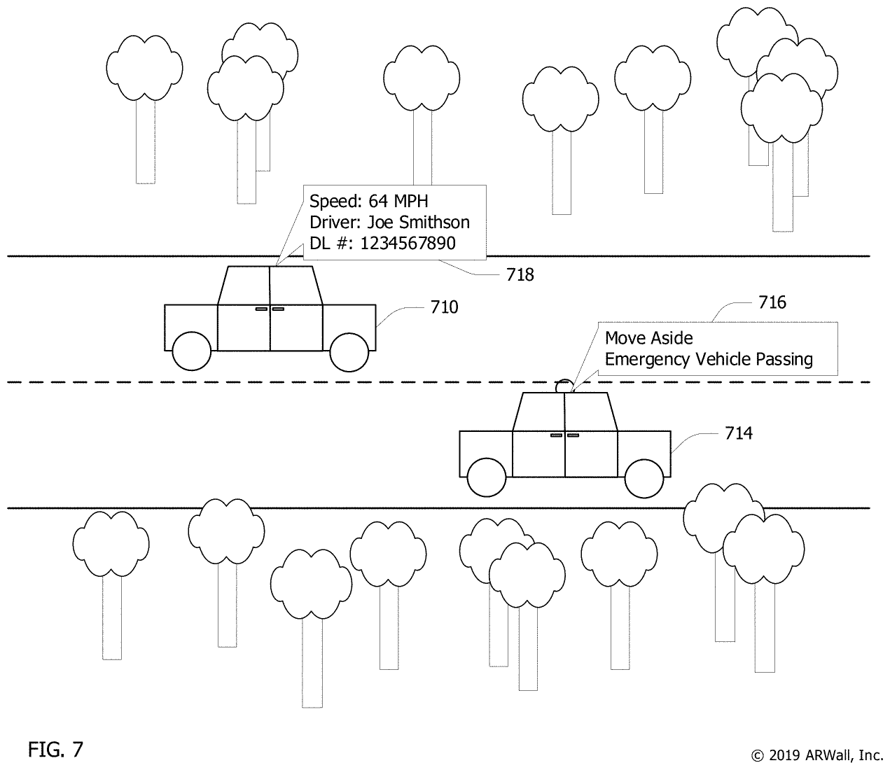

FIG. 7 is an example of an augmented reality display integrated with two of the two automobiles moving down a roadway, where one of the automobiles is a first responder vehicle. Here, the vehicle 710 includes a three-dimensional representation 718 that is providing relevant information to a first responder vehicle 714. The first responder vehicle 714 may be on its way to an emergency (hence it's three-dimensional representation 716 is a warning to move aside).

However, the first responder vehicle 714 may incorporate specialized privileges such that it is able to access information about the automobile 710, or any automobile, as it travels. This may be enabled by short-range communications as discussed with reference to FIG. 6 wherein the automobile 710 provides this information directly. Alternatively, this may be enabled by external sensors on the first responder vehicle 714 detecting information about the vehicle (e.g. a license place, or a short-range VIN provided wireless to the first responder vehicle 714) that is then, in turn, transmitted through the internet to databases where information is obtained.

This information may provide safety and arrest record information to the first responder or indicate that a given car is identified as stolen. Here, that includes a driver's license number, a name, and the current speed. For a fire truck, the information may be the expected residents of a given building as the firemen are travelling to that residence, or superimposed over the residence once they arrive, so they know the names and ages of individuals they should be seeking when they enter a burning building. For an ambulance, it may be information regarding the medical history of a patient that they are approaching. The combination of a transmitted identification number or other identifying information, and the internet, as well as the capability to provide three-dimensional representations associated with real-world physical objects enables the display devices discussed herein to provide timely, appropriate information, in a way that is tailored to the viewer.

The information may be seen, for example, on the windshield or side-view windows of the ambulance, fire truck, or police vehicle as it moves toward the emergency situation. Within the vehicle, interior sensors may track the position and gaze of the viewer so that the information can be provided on a display (window) visible to the relevant, first responder viewer inside the vehicle. The information may be the best that is available to the vehicle as it moves. For example, the residents of the building to which a fire truck is proceeding. The exterior sensors may not be capable, without facial recognition capabilities, of independently distinguishing individual humans once a vehicle arrives at a scene, but on the way to that scene, or as the relevant address or car (e.g. license plate) draws into view, the relevant information may be displayed on the associated windows of the vehicle in which the first responders are travelling.

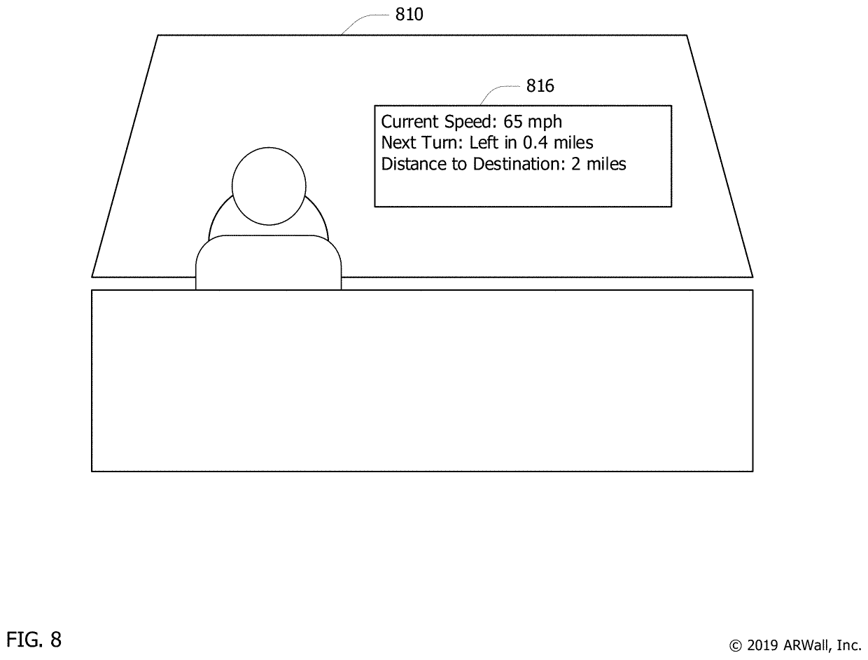

FIG. 8 is an example of an augmented reality display integrated within an automobile. Here, the display is integrated with a windshield. As the driver moves the automobile 810 down the road, a three-dimensional representation 816 may provide turn-by-turn directions, as well as information on the current speed of the automobile. Other information may be provided such as advertisements, overlays, popups, characters, automobiles that are not actually present, and other capabilities.

Vehicles may be networked together to enable the augmented reality viewing experience. Different cars either outfitted with augmented reality displays or not could connect to a network all with a single theme. A certain car manufacturer could outfit its vehicles to all be on the same network. On a certain day of the week, the car company could have a “retro day” where all cars made by that manufacturer appear to be cars from the 60's or 70's to viewers that have an augmented reality display. For example, Ford could have a “Mustang Day” in which every Ford Mustang on the road would appear, to others using augmented reality displays, to be a '67 mustang or other retro Mustang model.

The augmented reality displays on a network could also be configured to have certain augmented reality display holidays or celebrations. In anticipation of a Batman movie being released, movie producers could pay to have certain car models displayed as a Batmobile or Jokermobile to build anticipation for the new movie. Other cars could also simply display what appear to be decals or billboards or advertising marquees for certain events or products.

Visible indicators on the exterior of a vehicle may be detected by a sensor. For example, if a plumber's van with a QR code drives by, the sensor (e.g. a camera) may pick up on the QR code. The augmented reality display may then generate an advertisement linked to the QR code on the plumber's van, and the advertisement will be displayed as an overlay of the plumber's van through the augmented reality display. In another embodiment, all cars of a manufacture could emit certain signals that when picked up by other cars cause the cars to sparkle or change color, letting someone know the similar brand is nearby. As the passenger looks out to the world, not only do they see what a normal passenger would see, but they also see other objects generated by the augmented reality display. The process thus changes the outlook and perception of people inside the vehicle.

The augmented reality display may be a single window (e.g. the windshield) or may be multiple windows (windshield, side windows, and back glass). In other cases, the augmented reality display may only be a subset of one window or an independent display. The augmented reality display may be implemented as a transparent display, as a projection onto a screen or window, or may be an independent display. In yet another case, the augmented reality display may be a mobile device (e.g. a cell phone) or an augmented reality display designed to be worn by a driver while driving.

In one embodiment, communication between the augmented reality display and outside world is enabled through a cellular network. The augmented reality display would pick up signals through a cellular network, and display AR objects on the window based on the signal received. The cars themselves, the passenger's cellphone or another device in the car could have connectivity to a cellular network and relay information that way. In another embodiment, all cars that are part of the network could be part of a peer to peer network in which the network is promulgated by the actual automobiles that use the AR network.

In still other examples, the system could emulate a drive-in movie, users could create drive movies in which a movie is displayed over the augmented reality display that only makes sense if a person is driving. For example, when driving in New York, to pass the time the augmented reality display could display scenes that show Godzilla is attacking the city and the passenger of the vehicle is trying to escape. This could lead to gamification of the driving experience or a typical “directions” experience where a driver has to “turn away” from Godzilla in order to escape it and arrive safely at soccer practice with their kids. The entire family may view the exterior game that is really a hidden version of a simple turn-by-turn directions program.

Users could also create marks on the outside or sides of buildings that are invisible to the naked eye, but when viewed through the augmented reality display show an AR animation. Instead of putting actual graffiti on buildings, users could draw an animation and associate the animation with a fiducial marker or other signal. The marker could be placed on the side of a building, and when an augmented reality display user drives by, they could see the graffiti through the augmented reality display.

Road signs and notifications could also be viewed through the augmented reality display. Instead of posting a sign that says “Road Out”, “Lane Closed”, or a new speed limit, the augmented reality display could display the notification and be deleted when no longer needed. Virtual traffic conditions (not actually present) could also be posted over a freeway or other road indicating to a passenger what the estimated time of arrival is and if there is an accident.

Additionally, the augmented reality display could be configured to view “channels” that a user selects. For example, law enforcement could have access to a certain channel that displayed only information law enforcement would be allowed to see, such as who owned what vehicle, whether there was an arrest warrant out for the owner of a certain vehicle, or whether a certain vehicle on the road was stolen. This information could appear automatically over vehicles on a roadway as the police officer moves.

A city could also have programming of certain scenes to be displayed on an augmented reality display, but restrict access to citizens of the city. Furthermore, there could be “homebrewed scenes” that users create and corelate to certain geographic locations. A passenger could cycle through what stations they wanted to use with their smartphone or other controller of the augmented reality display based on what they wanted to see.

In one embodiment a single automobile is outfitted with windows capable of showing augmented reality projections. The car would also be outfitted with detection means such as Lidar, antenna, satellite feeds, Wi-Fi, Bluetooth, or other wireless communication systems that allow it to sense signals coming from other vehicles or objects. Based on signals from other objects, the windows can change and render a different reality based on the signal received. One could appear to be in the South of France, or on Mars, on in the midst of an alien invasion.

In another embodiment an automobile's own sensor technology could be utilized to transmit signals and create its own network using its sensors and sensors from other vehicles. This network could operate using the Internet with vehicles communicating indirectly through cellular or satellite networks. Alternatively, the vehicles could communicate directly via a peer-to-peer system while operating on a particular roadway such that the vehicles communication information (for display or otherwise) moves directly from one to another. The sensors included in and creating the network could consist of cameras, GPS positioning systems, radio antenna, antenna, radar, ultrasonic sensors, laser range finder, aerial sensor, altimeters, gyroscopes, tachymeters, Lidar.

The windows of an ambulance or other emergency vehicle may be outfitted with the augmented reality displays. If another car on the road is in an accident or in peril, the car will appear to flash red or another color on the ambulance window. In another embodiment someone in distress can activate a signal on their smartphone that will make the person or a designated area flash, so paramedics or police will have an easier time finding the individual or their location. Using similar capabilities, or computer vision recognition, vehicles fitted with appropriate exterior sensors and windows capable of displaying three-dimensional content may be presented with an augmented reality view of virtually any environment, if that environment includes physical cues (e.g. QR codes, bar codes, messages encoded in visual displays) or non-physical cues (e.g. GPS coordinates indicating the vehicles are in certain locations, accessing particular cellular or wireless networks) can trigger the activity of the display to show additional or different content or information relevant to the viewer.

In another embodiment, if a driver utilizes GPS functions from, for example, Google® maps or Waze®, rather than being forced to look at their smartphone, the GPS instructions will be overlaid on the windows. An arrow pointing them in the right direction, or the lane a driver needs to be in, would be displayed showing the driver where they need to go. Law enforcement and emergency vehicles could also be outlined. Many cars also have accident prevention features which could also be incorporated into the augmented reality display. For example, some luxury vehicles currently have sensors that beep when a driver is about to hit someone or swerves out of their lane. The smart window could flash in a corresponding window to whichever sensor detects that something is wrong. A text message or notification from a user's smartphone could also display on the window rather than have a user bend down to reach the smartphone.

In other embodiments a real life adblocker is generated by the augmented reality display. The vehicle could detect when an annoying billboard, vehicle decal, bus stop poster, or other advertisement is displayed and simply render an animation that covers the advertisement. In other embodiments, the AR wall could render an animation that makes the advertisement blend in with its surroundings, so the passengers are not even aware there was an ad in the first place. For example, if a billboard was on top of a building, the AR wall could either generate a giant rectangle that simply blocked the billboard or could render skyline over the billboard.

In another embodiment, the augmented reality display could be programmed to give a virtual tour of where someone is driving. For example, if someone is driving near Washington D.C. or Gettysburg, signals emitted from the area could request if a user wants to have a virtual tour of the area as they drive through. If the user selects yes, overlays on the augmented reality display could show reenactments of the battle of Gettysburg, or the buildup of Washington D.C. over time.

The augmented reality displays may also have haptic feedback or touch screen (or a screen in the air enabled by LIDAR or depth sensors within the vehicle) capabilities. Not only would the augmented reality display be able to display augmented reality images, but a user could touch and input data by touching the augmented reality display. The augmented reality display could also be linked to a person's social media account and incorporate information from social media on the augmented reality display. For example, if a user connected their Facebook account to the augmented reality display and drove through Paris, the augmented reality display could post an indication that one of their Facebook friends had been to Paris and taken a picture at a location. A photo album uploaded to Facebook at a particular location could even be displayed over the augmented reality display.

The augmented reality display can also incorporate data from other websites and ranking services to display certain information relevant to passengers passing by a certain area. A Yelp or Yellowbook plug in to the augmented reality display could display the ranking or number of stars a particular restaurant has received as well as post relevant reviews if someone was looking for a restaurant or destination. A person driving by a restaurant could have the augmented reality display automatically display a menu and pictures of cuisine from a destination as a user drove by.

The augmented reality display can be outfitted with a VOIP or video calling feature that make it appear as if a person was standing on the other side of a window rather than awkwardly on the other side of a screen or within the automobile itself via projection. A user looking out the augmented reality display would see the person they are speaking with as if they were standing right outside (or inside). The augmented reality display could also display regular video chatting services such as Skype® and Facebook® video calling.

In another embodiment cars outfitted with augmented reality displays and connected to the same network could play games with one another. The augmented reality display could generate parameters for the game, and passengers using their smartphone or other computing device could interact with one another through their augmented reality displays. For example, in a game of augmented reality “punch buggy” a user would need to circle a Volkswagen they see on their augmented reality display faster than other passengers in other cars in the area. A user that identifies the punch buggy would be awarded a point.

In another embodiment the augmented reality display could completely distort the outside world to match a particular theme or style the person wanted. For example, there could be a “Minecraft” theme in which the entire outside world is displayed as pixels as in the popular game Minecraft®. There could be a historical theme in which the outside world looks the way an area looked years ago. For example, a city could create a virtual panorama of what the city looked like in the 1800s. Cars driving through the city could download data that the city provided and have their augmented reality display display the outside world to be what the city looked like in the 1800s.

The augmented reality display could also be applied to the moonroof or sunroof of a car. If driving at night, passengers could look up and see an explanation of what stars and constellations are in the sky. The augmented reality display could also display fireworks or blimps with a certain message.

In other embodiments the augmented reality display may act as a conventional heads-up display (HUD). For example, a user's text messages or a notification of an incoming call could appear on the window. Social media notifications and general smartphone notifications could also be displayed on the windows.

The augmented reality display could also work with its own software development kit (SDK). Passengers could design their own maps and animations that overlay on the augmented reality display. The SDK may only be available to vehicle manufacturers and licensees, or may be available to almost anyone, depending on the situation. Taking safety into account, passengers may or may not be able to mix and match designs and post recommendations for what designs should be displayed where.

The augmented reality display may also work in the reverse, altering the appearance of passengers inside the vehicle to those in the outside world. For example, during baseball season, a user could program the augmented reality display to project LA dodger hats on all the passengers within the car. The augmented reality display could also illustrate more encapsulating animations such as a fish tank aquarium or a scene from a movie involving a car.

If a law enforcement vehicle were tracking a particular vehicle, rather than have officers scan with their eyes for a certain make and model, the augmented reality display could highlight cars on the road that matched a suspect's car's make and model. The augmented reality display coupled to a computer could also display advance statistics about the occupants of the car, such as how many people are in the car and if there appear to be any weapons in the car.

The augmented reality display need not be applied only to cars, any vehicle that moves could utilize the technology, such as trains, mobile homes, motorcycles, amusement park rides, boats, airplanes. Alternatively, any augmented reality capable device may be capable of viewing and interacting with augmented reality content provided by or associated with a vehicle or other object (e.g. home, person, animal, toy, etc.).

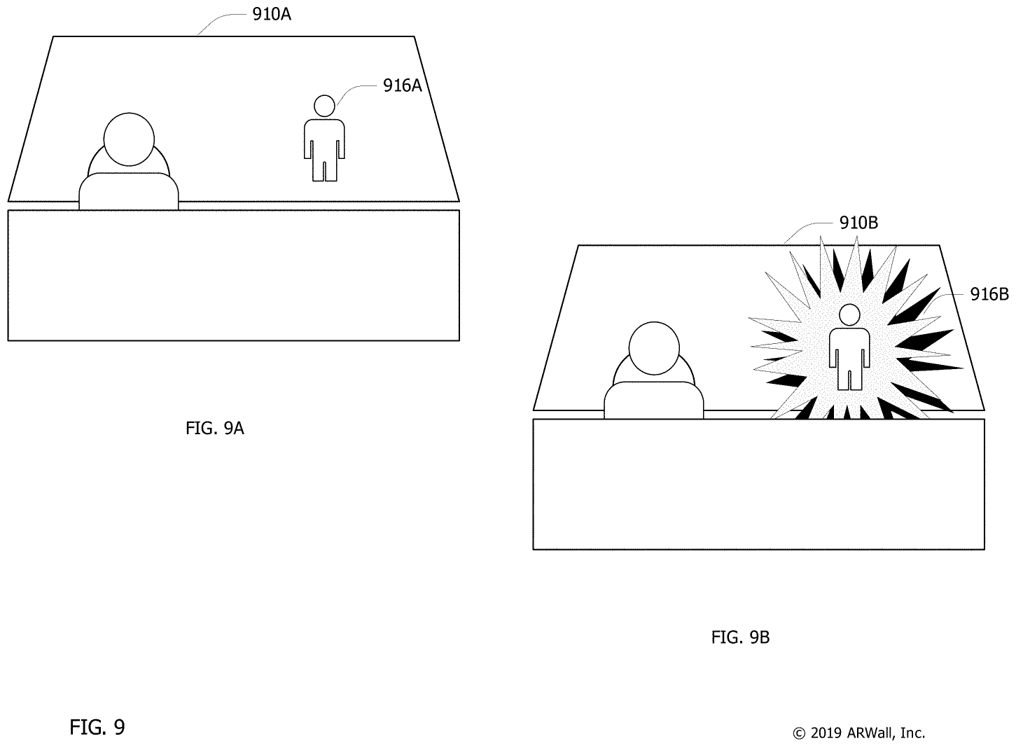

FIG. 9, including FIGS. 9A and 9B, is another example of an augmented reality display integrated with an automobile. Beginning with FIG. 9A, the automobile 910A windshield includes a display capable of showing augmented reality content. An individual 916A is visible through the windshield. Turning to FIG. 9B, the same individual 916B is now illuminated in the windshield of the automobile 910B. This illumination may operate based upon the detection of the individual by the external sensors of the automobile and may be used to ensure that the driver sees the individual 916B. For example, while driving at night, individuals, animals, or other road hazards may be difficult to see in the roadway. The augmented reality functions of the present system may enable a three-dimensional representation of the individual to incorporate highlighting of some kind to aid in night time vision.

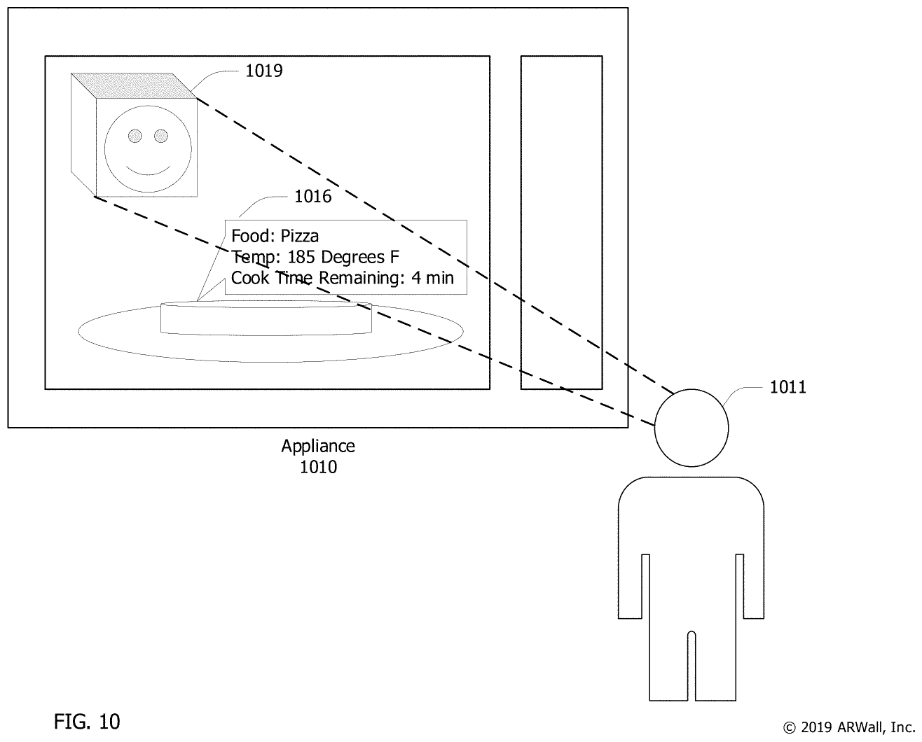

Turning to FIG. 10, an example of an augmented reality display integrated into an appliance is shown. The appliance 1010 is a microwave. Here, the internal sensors can detect the temperature of the microwave pizza being cooked, may even be able to apply neural networks to ascertain that the item being cooked is a microwave pizza, and can determine the cook time remaining using the internal clock of the microwave itself. A popup 1016 may appear over the pizza, or may be animated or otherwise indicate that the pizza is in process and provide supplemental information to that effect.

As with the automobile, the microwave includes external sensors that in this case track the position of the viewer 1011. Here, the viewer has a perspective to which the three-dimensional representation is adjusted to correspond. As anyone who has used a microwave knows, it can be a boring impatient time for a hungry person, particularly a hungry child. So, a three-dimensional character or object 1019 may appear on the microwave in response to the microwave's sensors noting that a human is present and waiting. The character may be general, unrelated to anything, or from a desired television program or game. The character may appear in response to the detection of the pizza being cooked and be an Italian chef associated with the brand of pizza. The character may interact with the viewer 1011 or may put on a short show. The character may respond to the information detected by the internal sensors, e.g. reacting to the pizza being nearly-ready, and ready, or may comment on the melting cheese. All of this may be based upon information generated by the internal and external sensors, including the viewer's perspective. The chef could even follow the viewer as he or she moves around the room and be disappointed if the viewer leaves the room.

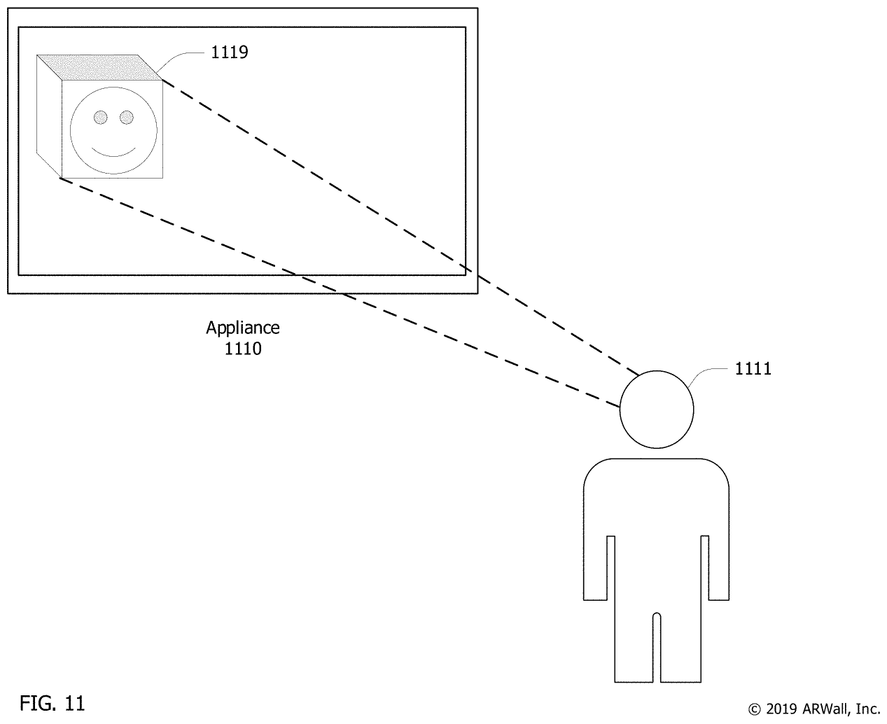

FIG. 11 is an example of an augmented reality display integrated into another appliance. This appliance 1110 is a television or other digital display. The appliance can incorporate internal and external sensors so that it may be aware of what is happening on the television as well as what is happening outside of the television. The viewer's perspective, location, and even eye gaze (watching or not) may be ascertained. The content 1119 on the appliance 1110 may alter based upon the viewer 1111 position.

If volumetric video is available, movement of the viewer's perspective, e.g. from right to left, may result in the scene shifting behind the characters acting on screen. In this way, the television may become effectively an actual “window” into a virtual, augmented reality virtual world. This type of shift is described more clearly in the Applicant's patent application identified above. In general, the appliance 1110 may respond to movement of the viewer so as to alter the perspective view of the background and, in the case of a television, foreground actors to respond to the perspective shifts by the viewer.

Even in non-volumetric content, a three-dimensional character may follow a viewer's head around the room so as to always be speaking “to” the viewer. Or, an on-screen digital assistant may operate on screen while facing a viewer.

As indicated above, some devices, such as the microwave of FIG. 10 or even the television of FIG. 11, may not incorporate sufficiently powerful processing capabilities to perform the sensor fusion, data integration, and rendering of associated content. In such cases, that functionality may be offloaded to the integration server 220 (FIG. 2) and the resulting three-dimensional representations may be sent, frame-by-frame, back to the appliance for display. As an added benefit, the reliance upon these capabilities in some cases will be short-lived (e.g. while heating a pizza in a microwave or while interacting with a digital assistant). Accordingly, while there will be some long term or ongoing data integration and rendering capabilities, at least initially, many of these will be short term use for only a few moments or minutes. Accordingly, the scaling of computational capabilities necessary to service potentially many automobiles, appliances, or other objects will be relatively small at the outset.

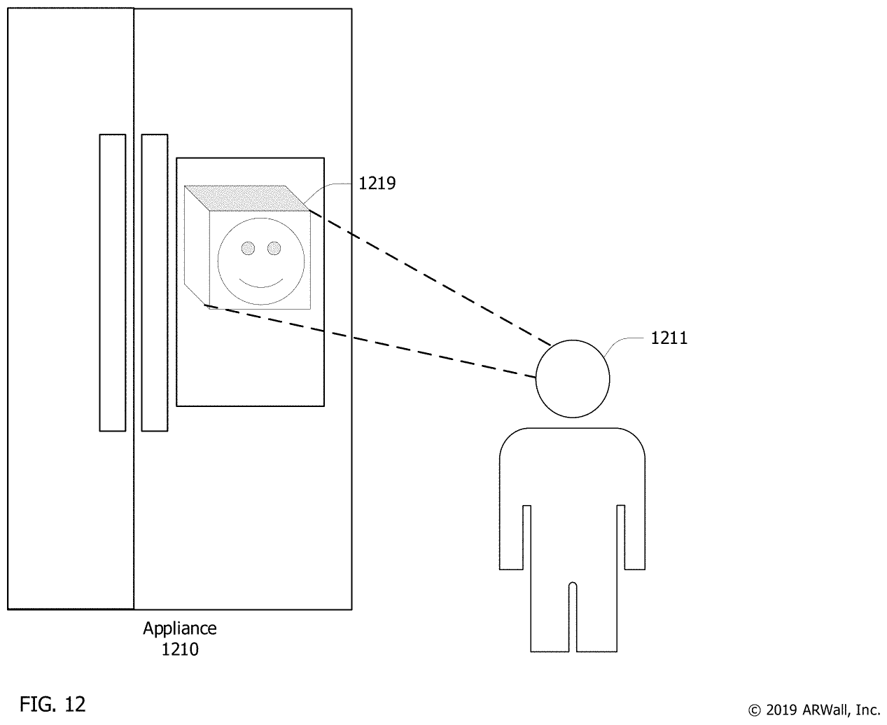

FIG. 12 is an example of an augmented reality display integrated into a different appliance. This appliance 1210 is a refrigerator. As is more common modernly, this refrigerator has a display on its face. The display maybe occlusive or may be transparent or translucent. A viewer 1211 may see what is in the refrigerator, or may not, or the display itself may be used to “show” a viewer 1211 what is available within the refrigerator. Whatever the case, the display provides an interesting opportunity to merge reality and augmented reality. For example, as a viewer 1211 approaches, the refrigerator may merely be translucent so the viewer 1211 can see an apple and a banana inside. Then, as the viewer stands looking, the translucency may give way to a camera-provided view of the interior of the refrigerator that may then be overlaid with augmented reality or purely virtual reality content.

For example, an apple may sprout legs, while the remainder of the refrigerator content remains constant. The legs may be purely digital. The entire image may be a freeze-frame captured as the viewer 1211 approached. The apple may then begin a dance with a banana that has also sprouted legs. The two may continue to dance while a viewer 1211 watches. The viewer's perspective can be tracked using external sensors. The viewer may move relative to the window/display, and the background may shift appropriately as well as the perspective on the three-dimensional apple and banana, reliant upon the internal sensors in the refrigerator. Then, the apple and banana may eventually return to a normal state. More humorously, the apple and banana may continue dancing until the user pulls the door open when they abruptly stop. As the viewer 1211 opens the refrigerator, all he or she sees is the fruit sitting there, ready to be eaten, rather than dancing.

Description of Processes

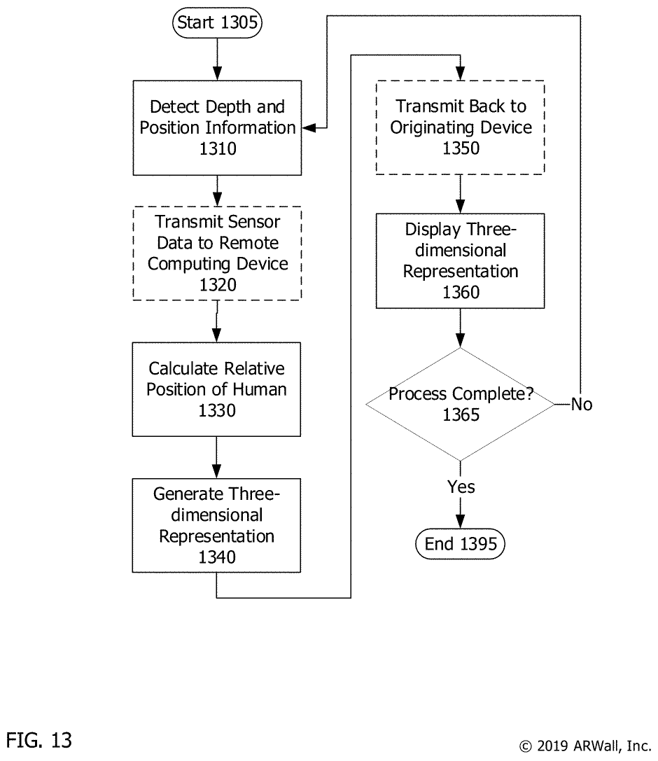

Referring now to FIG. 13, a flowchart of a process of generating augmented reality content for an augmented reality display is shown. The flowchart has a start 1305 and an end 1395, but may take place many times or have many iterations of the process in various phases simultaneously. The process starts at start 1305 when the system, described herein, is instructed to begin provide three-dimensional representations on one or more of the displays.

Following the start 1305, the process begins with detection of depth and position information at 1310. As indicated above, this step is two-fold. First, the depth and position (and orientation and location) of the viewer or viewers are detected. For the automobile, these are internal viewers, relative to displays within the automobile or on the windows of the automobile. For appliances and similar objects, this may be a viewer or viewers external to the appliance or other object. The viewer position relative to the displays is important for projecting in three dimensions within the display in such a way that the perspective appears correct to the viewer.

Second, the depth and position (and orientation and location) for any other objects being tracked is detected. For automobiles, these may be the road itself, adjacent or nearby cars, people, bikes, hazards, road signs, billboards, street signs, and almost anything else one is likely to encounter while driving. For appliances, these may be the state of the food, the presence or non-presence of food (e.g. barcodes on milk boxes in a fridge may demonstrate their presence or non-presence), the temperature of the appliance or food, some aspect of the state of the appliance or other object, or other information.

Once this depth and position information is ascertained, along with any other relevant data, the information may be transmitted to a remote computing device at 1320. This may be an optional step. As indicated above, some devices, automobiles, and appliances may lack sufficient computing power to accurately integrate sensor data or to generate rendered three-dimensional representations. If this is the case, then the capturing sensors may transmit that data to a remote computing device for integration.

Using the sensor data, the relative human position is calculated at 1330 so that a three-dimensional representation may be generated to accurately reflect the perspective of the human viewer. In particular, as described above, the three-dimensional representation may be an augmented reality character, an object, an entire scene, or some other three-dimensional representation. As such, there is relevant perspective information that is derived as a result of the human viewer's perspective of that scene, object, character or the like. In the case of an automobile example above, it would be incorrect, and appear unusual to see Herbie from the perspective of a front-on viewer while driving beside Herbie. Instead, the perspective will be shifted such that the perspective matches that of the human viewer, and the display relating to the automobile driving next to the viewer will thereby appropriately correspond. That is the process that takes place at this step 1330.

Once that perspective is ascertained from the various internal and external sensors, the three-dimensional representation is generated at 1340. In the augmented reality Herbie example, this is when the three-dimensional character/object Herbie is generated for superimposition over the real-world automobile driving alongside the driver. The three-dimensional character may be transmitted as a series of frames of two-dimensional video or may be dynamically overlaid, by the display and associated computing device, as a viewer looks on.

In optional cases where the data was transmitted to a remote computing device (e.g. the integration server 220 of FIG. 2), the next step is to transmit back the rendered data or integrated sensor data to the originating device at 1350.

Next, the three-dimensional representation is displayed on the display at 1360. This may merely be a single frame of three-dimensional representation with subsequent frames generated as new data is provided by the sensors.

Accordingly, a determination is made whether the process is complete (e.g. the Herbie advertisement is completed, the pizza has been cooked, etc.). If not (“no” at 1365), then the process continues with detection of new depth and position information at 1310 through generation of a new frame of video. If so (“yes” at 1365), then the process ends at 1395.

Closing Comments

Throughout this description, the embodiments and examples shown should be considered as exemplars, rather than limitations on the apparatus and procedures disclosed or claimed. Although many of the examples presented herein involve specific combinations of method acts or system elements, it should be understood that those acts and those elements may be combined in other ways to accomplish the same objectives. With regard to flowcharts, additional and fewer steps may be taken, and the steps as shown may be combined or further refined to achieve the methods described herein. Acts, elements and features discussed only in connection with one embodiment are not intended to be excluded from a similar role in other embodiments.

As used herein, “plurality” means two or more. As used herein, a “set” of items may include one or more of such items. As used herein, whether in the written description or the claims, the terms “comprising”, “including”, “carrying”, “having”, “containing”, “involving”, and the like are to be understood to be open-ended, i.e., to mean including but not limited to. Only the transitional phrases “consisting of” and “consisting essentially of”, respectively, are closed or semi-closed transitional phrases with respect to claims. Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements. As used herein, “and/or” means that the listed items are alternatives, but the alternatives also include any combination of the listed items.

It is claimed:

1. A system for display of augmented reality content comprising:
at least one sensor generating sensor data by detecting depth and position information for at least one human separate from an object into which the at least one sensor is integrated;
a computing device for:
generating a three-dimensional representation of at least one computer-generated object with a perspective of the at least one computer-generated object being determined based upon the depth and position information for the at least one human;
transmitting the three-dimensional representation to at least one display;
the at least one display for displaying the three-dimensional representation.

2. The system of claim 1 wherein the object into which the at least one sensor is integrated is an automobile.

3. The system of claim 2 wherein the three-dimensional representation of at least one computer-generated object is information related to a present location of the automobile, a present location of the automobile relative to other automobiles or humans, an advertisement for a nearby commercial establishment, traffic information, emergency services information, routing information for traffic guidance, a user interface for an electronic setting for the automobile, or a game.

4. The system of claim 3 wherein the at least one sensor faces the interior of the automobile, while at least one other sensor faces the exterior of the automobile and tracks at least one of: the present location of the automobile, the present location of the automobile relative to other automobiles or humans, or a presence of nearby commercial establishments.

5. The system of claim 2 wherein the at least one display is integrated into a window of the automobile or projected within the automobile in such a way that the three-dimensional object appears to occupy empty space within an interior of the automobile.

6. The system of claim 1 wherein the at least one sensor is multiple sensors selected from the group: LIDAR, video cameras, infrared cameras, light field projectors, global positioning sensors, depth cameras, and high frame rate cameras.

7. The system of claim 1 wherein the computing device is in a location remote from the object and further wherein:
the sensor data is transmitted to the computing device via a network;
the computing device operates to create the three-dimensional representation; and
the three-dimensional representation is transmitted back to the object via the network for display.

8. The system of claim 7 wherein the object is a home appliance, a television, a projector, a computer display, or a stand-alone display device.

9. The system of claim 8 wherein the object displays the three-dimensional representation including information relevant to a home in which the object is present and the depth and position information for the at least one human causes the information to be seen from the perspective of the at least one human.

10. The system of claim 1 wherein the at least one human is multiple humans, each of whom are tracked individually so that the three-dimensional representation may appear from an appropriate perspective for each of the multiple humans.

11. A method for display of augmented reality content comprising:
generating sensor data using at least one sensor by detecting depth and position information for at least one human separate from an object into which the at least one sensor is integrated;
generating a three-dimensional representation of at least one computer-generated object using a computing device, the three-dimensional representation including a perspective of the at least one computer-generated object being determined based upon the depth and position information for the at least one human;
transmitting, using a network, the three-dimensional representation to at least one display;
displaying the three-dimensional representation on the at least one display.

12. The method of claim 11 wherein the object into which the at least one sensor is integrated is an automobile.

13. The method of claim 12 wherein the three-dimensional representation of at least one computer-generated object is information related to a present location of the automobile, a present location of the automobile relative to other automobiles or humans, an advertisement for a nearby commercial establishment, traffic information, emergency services information, routing information for traffic guidance, a user interface for an electronic setting for the automobile, or a game.

14. The method of claim 13 wherein the at least one sensor faces the interior of the automobile, while at least one other sensor faces the exterior of the automobile and tracks at least one of: the present location of the automobile, the present location of the automobile relative to other automobiles or humans, or a presence of nearby commercial establishments.

15. The method of claim 12 wherein the at least one display is integrated into a window of the automobile or projected within the automobile in such a way that the three-dimensional object appears to occupy empty space within an interior of the automobile.

16. The method of claim 11 wherein the at least one sensor is multiple sensors selected from the group: LIDAR, video cameras, infrared cameras, light field projectors, global positioning sensors, depth cameras, and high frame rate cameras.

17. The method of claim 11 wherein the computing device is in a location remote from the object and the method further comprises:
transmitting the sensor to the computing device via the network;
creating the three-dimensional representation using the computing device; and
transmitting the three-dimensional representation back to the object via the network for display.

18. The method of claim 17 wherein the object is a home appliance, a television, a projector, computer display, or a stand-alone display device.

19. The method of claim 18 wherein the object displays the three-dimensional representation including information relevant to a home in which the object is present and the depth and position information for the at least one human causes the information to be seen from the perspective of the at least one human.

20. The method of claim 19 wherein the at least one human is multiple humans, each of whom are tracked individually so that the three-dimensional representation may appear from an appropriate perspective for each of the multiple humans.

21. A system for display of augmented reality content comprising:
at least one sensor capturing sensor data by detecting depth and position information for at least one human separate from an object into which the at least one sensor is integrated and at least one other object separate from the at least one human and the object;
a first computing device for transmitting the sensor data to a second computing device;
the second computing device, remote from the first computing device for:
generating a three-dimensional representation of at least one computer-generated object with a perspective of the at least one computer-generated object being determined based upon the depth and position information for the at least one human and the at least one other object;
transmitting the three-dimensional representation to at least one display;
the at least one display for displaying the three-dimensional representation.
